(19) United States
(12) Patent Application Publication
(10) Pub. No.: US 2026/0061538 A1
(43) Pub. Date: Mar. 5, 2026

(54) POWER TOOL WITH A DUST COLLECTION BOX, AND DUST COLLECTION BOX

(71) Applicant: Hilti Aktiengesellschaft, Schaan (LI)

(72) Inventors: Rory BRITZ, Starnberg (DE); Markus HARTMANN, Mauerstetten (DE)

(21) Appl. No.: 19/106,954

(22) PCT Filed: Aug. 29, 2023
(86) PCT No.: PCT/EP2023/073736

§ 371 Date: Feb. 26, 2025

(30) Foreign Application Priority Data
Sep. 13, 2022 (EP) 22195277.3

(51) Int. Cl. B23Q 11/00; B25D 17/20

(52) U.S. Cl. CPC B23Q 11/0046; B23Q 11/0071; B25D 17/20

(57) ABSTRACT

A power tool, which is connectable to an elongate tool extending forward in a spatial direction, wherein the power tool is designed to drive the tool to perform a rotating and/or striking movement. The power tool includes a dust collection box for extracting dust-laden air from a working region of the power tool, the dust being able to be filtered out from the dust-laden air by means of a filter. A virtual center plane can be placed through a main body of the power tool and/or of the dust collection box, the virtual center plane dividing the main body into two halves, wherein an inlet of the dust collection box for the dust-laden air is arranged predominantly on the one side, and the filter of the dust collection box predominantly on the other side, of the virtual center plane. A dust collection box for a power tool, wherein the inlet and the filter of the dust collection box are present on different sides, i.e. in different halves of the dust collection box.

The present invention relates to a power tool, which is connectable to an elongate tool extending forward in a spatial direction, wherein the power tool is designed to drive the tool to perform a rotating and/or striking movement.

### BACKGROUND OF THE INVENTION

In the field of power tools, especially in the field of hammer drills, dust collection boxes which can be connected to the power tool in order to extract dust-laden air from a working region of the power tool are known. Power tools can be connected to tools with which work can be performed. In the case of a hammer drill, the hammer drill can be connected to an elongate tool, which can be driven by the device to perform a rotating and/or striking movement. In the case of what are referred to as “onboard” dust collection boxes for power tools, two different types of dust collection boxes are primarily known: firstly, dust collection boxes in which the suction channel between the working region and the dust collection box is guided along the tool on one side of the tool of the power tool are known. Secondly, dust collection boxes in which the suction channel is guided in or in the vicinity of a plane, the plane including a working axis and a handle axis of the power tool, are known. Said plane is therefore preferably also referred to as the “working plane” of the power tool. The working axis corresponds to the axis in which the tool of the power tool is located, with the handle axis including the main handle of the power tool.

### SUMMARY OF THE INVENTION

The dust collection boxes with the lateral guiding of the suction channel frequently have a good extraction performance, but are often very large and unwieldy, and therefore, when connected to such a dust collection box, the power tool also becomes very large and unwieldy. This can make the power tool difficult to handle and make working with the power tool laborious and less comfortable. In addition, power tools with such dust collection boxes frequently have to be disassembled prior to transport in a transport crate in order to be able to stow the power tool and the dust collection box in the transport crate. However, this disassembly and stowing can cost working time and is therefore undesirable.

In the case of the dust collection boxes in which the suction channel is located in the working plane of the power tool, the filter for filtering out the dust from the dust-laden air is frequently located on a front or rear wall of the dust collection box. This can disadvantageously cause dust to collect on the filter when working with the power tool on a substrate, such as a floor, or on a ceiling, i.e. overhead. This can cause the filter to rapidly clog up such that, for example, only a small number of boreholes can be produced with the power tool before the filter has to be replaced or cleaned.

It is an object of the present invention to provide a power tool which combines the advantages of the known designs. In particular, the intention is to make it possible to produce as great a number of boreholes as possible during each use of the power tool before the filter has to be replaced or cleaned. In addition, the intention is for the dust collection box to be provided to be particularly compact and handy in order to provide a handy and comfortable power tool. The experts would appreciate it if a cost-effective and easily replaceable filter could be provided for the dust collection box and if the dust collection box could be particularly leakproof in order to make the best use of an existing suction performance and not to have any leakage.

The present invention provides a power tool which is connectable to an elongate tool extending forward in a spatial direction. The power tool is designed to drive the tool to perform a rotating and/or striking movement. The power tool comprises a dust collection box and is releasably connectable thereto, wherein the dust collection box is designed to extract dust-laden air from a working region of the power tool and to filter out the dust from the dust-laden air by means of a filter such that the dust can be collected in an interior space of the dust collection box until the latter is emptied. A virtual center plane can be placed through a main body of the power tool and/or of the dust collection box, the virtual center plane being designed to divide the main body in a sectional illustration, looking from a forward spatial direction, into a first side and a second side. In this case, an inlet of the dust collection box for the dust-laden air is arranged predominantly on one side of the center plane, while the filter of the dust collection box is arranged predominantly on the other side of the center plane.

It is preferred within the meaning of the invention that the first side of the main body of the power tool and/or of the dust collection box can be designated as the left side, while the second side of the main body of the power tool and/or of the dust collection box can be designated as the right side. In this case, the main body of the power tool and/or of the dust collection box is preferably viewed from a forward spatial direction, the forward spatial direction preferably being determined by the position of the tool of the power tool, while the main body of the power tool preferably determines the rear region of the power tool and the rearward spatial direction. The main body may be a main body of the power tool, which comprises, for example, the motor, the impact mechanism and/or the battery of the power tool. It may also be preferred within the meaning of the invention that the main body is a main body of the dust collection box. Preferably, the virtual center plane divides the main body of the power tool or the dust collection box conceptually into two sides or halves.

It is preferred within the meaning of the invention that a larger part of the inlet of the dust collection box is arranged on the one side of the power tool or its main body, while a smaller part of the inlet of the dust collection box is arranged on the other side of the power tool or its main body. Preferably, the larger part of the inlet of the dust collection box can be designated as “a predominant part of the inlet of the dust collection box” within the meaning of the invention.

It is preferred within the meaning of the invention that the larger part, i.e. the predominant part, of the filter is arranged on the one side of the power tool or its main body, while the smaller part of the filter is arranged on the other side of the power tool or its main body, with the larger portions of the inlet and the filter being arranged on opposite sides of the main body of the power tool.

The wording that a “predominant” part of an object lies on one side of the power tool or of the dust collection box, means, within the meaning of the invention, preferably that the object lies completely or partially, and if partially, with the larger of the at least two parts, on the one side or half of the power tool or of the dust collection box. The wording of the predominant part includes the fact that the object is arranged completely on the one side or half of the power tool or of the dust collection box. It is preferred within the meaning of the invention that a larger of at least two parts of the object is arranged on the one half of the power tool or of the dust collection box.

This means, according to the invention preferably, that the larger part of the inlet and the smaller part of the filter are arranged on the one side of the main body of the power tool and/or of the dust collection box, while the larger part of the filter and the smaller part of the inlet are located on the other side, i.e. opposite side, of the main body of the power tool and/or of the dust collection box. The separation into the two halves of the main body is brought about by the virtual center plane of the power tool and/or of the dust collection box, which can preferably coincide with the previously described working plane of the power tool. It is preferred within the meaning of the invention that, for example, the tool of the power tool or the axis of the tool is located in the working plane of the power tool. In addition, it may be preferred within the meaning of the invention that the virtual center plane of the power tool intersects the handle of the power tool and, if the power tool is a battery-operated power tool, the battery of the power tool, and substantially divides it centrally into two similar or symmetrical halves. The handle of the power tool can preferably be what is referred to as a D handle, which can be gripped by a user of the power tool in order to grasp the power tool and to guide it during the work.

With the invention it is advantageously possible to produce a particularly large number of boreholes without the filter having to be replaced or cleaned. This advantage of the power tool can be achieved especially in all three main use situations of the power tool (working on the floor, on the wall and overhead on the ceiling), because in none of the three main use situations is the filter covered by dust so that it rapidly becomes clogged or blocked. Owing to the arrangement and design of the dust collection box, the dust in the main use situations advantageously falls next to the filter, so that a “flooding” or “sugaring”of the filter is avoided by the invention.

A further advantage of the invention is that a particularly compact and handily designed dust collection box can be provided with the invention. This means that the system consisting of power tool and dust collection box can also be designed to be particularly compact and handy, and therefore the handling of the power tool can be considerably simplified for the user.

With the invention, the dust-laden air from the inlet of the dust collection box can first flow or be sucked into the interior of the dust collection box, where some of the dust is separated from the air flow and placed onto the bottom of the dust collection box. The air continues to flow through the filter, with the dust collection box comprising a suction unit for generating the air flow, with the air flow in the arrangement of the dust collection box in the power tool flowing through said suction unit last. At this point, the air flow is already substantially dust-free, because the dust has either been deposited inside the dust collection box or the dust has been filtered out of the air flow by the filter. In particular, the arrangement of the dust collection box inside the power tool can achieve a particularly good extraction performance. The arrangement of the dust collection box on the power tool is referred to as “asymmetric” within the meaning of the invention. Preferably, the dust collection box of the power tool is preferably referred to as an “asymmetric dust collection box” within the meaning of the invention, wherein the asymmetric arrangement of the components of the dust collection box is characterized in that the inlet of the dust collection box is arranged predominantly on one side of the main body of the power tool and/or of the dust collection box, while the filter of the dust collection box is arranged predominantly on the other or opposite side of the main body of the power tool and/or of the dust collection box. In particular, the effect achieved by the asymmetrical arrangement of the dust collection box is that the filter of the dust collection box is not covered by dust in any of the three main use situations of the power tool (working on the floor, on the wall and overhead on the ceiling).

This enables the power tool to drill a large number of holes without the filter of the dust collection box having to be cleaned or replaced. In this way, the working efficiency of the power tool can be significantly improved.

It is preferred within the meaning of the invention that the dust-laden air can be guided from the working region through a suction channel to the inlet of the dust collection box, the virtual center plane running through the suction channel. In other words, the suction channel is located centrally in the power tool or in the dust collection box, which is expressed by the fact that the virtual center plane intersects the suction channel and divides it conceptually into two substantially symmetrical halves. The advantages associated with dust collection boxes with the central arrangement of the suction channel around the virtual center plane of the main body can thus also be realized with the present invention. In particular, this includes a compact design, which allows for good and easy handling of the power tool.

It is preferred within the meaning of the invention that the suction channel is telescopic. Thus, the suction channel can advantageously be adapted to different lengths of the tool of the power tool or to different desired depths of the borehole.

It is preferred within the meaning of the invention that the power tool has a first seal, the first seal being designed to direct the dust-laden air into the dust collection box. Preferably, this first seal is present in the region of the inlet of the dust collection box.

It is preferred within the meaning of the invention that the dust collection box has a second seal, the second seal being designed to direct the purified air from the filter to a suction unit of the dust collection box. Preferably, the second seal is present in an upper region of the dust collection box.

Within the meaning of the invention, it is preferred that the power tool has a first seal for conducting the dust-laden air into the dust collection box and a second seal for conducting the purified air from the filter to a suction unit of the dust collection box, the first seal and the second seal being oriented in a substantially identical spatial direction. This means within the meaning of the invention preferably that the first and the second seal are substantially parallel and point substantially in the same spatial direction. The wording “substantially parallel” or “substantially in the same spatial direction” do not constitute unclear terms for a person skilled in the art because they know that, for example, the wording “substantially parallel” may include small deviations from an exact mathematical parallelism, with such small deviations being able to lie, for example, in a range of +/−5 degrees from the exact mathematical parallelism.

Within the meaning of the invention, it is particularly preferred that the first seal and the second seal are arranged at the same height within the power tool or within the dust collection box. In this way, the seals can be manufactured particularly cost-effectively. In addition, it has been shown that seals which are arranged in the manner described are particularly tight and have a good sealing effect with simultaneously little outlay. As a result, the existing suction performance of the dust collection box suction unit can be used particularly well and undesired leakages are effectively prevented.

Furthermore, an air guide element can be formed integrally in this way, as a result of which the in any case good sealing effect of the seals of the dust collection box can be further improved. It is therefore preferred within the meaning of the invention that the dust collection box has an air guide element, the air guide element being formed integrally. The air guide element can be designed, for example, as an air-guiding plate. However, it may also be preferred within the meaning of the invention that the air guide element comprises plastic or is formed from plastic. The air guide element can have a perforated bottom through which the air flow can enter an intake chamber of the suction unit of the dust collection box.

It is preferred within the meaning of the invention that the dust collection box has a third seal, the third seal being designed to seal an upper region of the dust collection box in relation to a lower region of the dust collection box.

It is preferred within the meaning of the invention that at least one of the seals is integrated in a filter frame of the dust collection box. It is preferred within the meaning of the invention that two seals and, particularly preferably, all three seals are integrated in a filter frame of the dust collection box. By integrating the seals in the frame of the filter, the seals of the dust collection box are regularly replaced, and therefore with the invention an “as good as new” sealing effect of the seals of the dust collection box can be generally ensured. It has been shown that the regular replacement of the seals of the dust collection box can advantageously significantly extend the service life of said dust collection box.

A filter consisting of folded filter papers is preferably used in the dust collection box. The filter designed in this way preferably has lamellae through which the air flow to be cleaned passes. Preferably, such a filter may be referred to as a lamella filter within the meaning of the invention. By means of the arrangement of the filter in the dust collection box, it can advantageously be ensured that the direct path or the shortest connection from the inlet of the dust collection box in the direction of the filter runs substantially parallel to a normal direction to the lamellae of the filter. This advantageously leads to the fact that the initially dust-laden air flow in this manner substantially only has direct contact with the outer lamellae of the filter and thus can only contaminate and clog these up. In order to reach the inner lamellae, it is preferred within the meaning of the invention that the air flow is diverted several times. This can reduce the dust load of the air flow and the air is filtered. In particular, this avoids the internal filter layers of the filter from becoming contaminated and clogged up. It is preferred within the meaning of the invention that the filter is designed as a lamella filter, wherein the direct path and/or the shortest connection through the dust collection box strikes substantially perpendicularly against the lamellae of the lamella filter.

It has been shown that by designing the filter as a lamella filter and by guiding the air flow through the dust collection box, a filter with fewer lamellas than in conventional dust boxes, as are known from the prior art, can be used. This means that the filter can be designed to be particularly compact and space-saving, and the dust collection box can be kept compact overall. In addition, the manufacturing costs for the filter can be reduced by reducing the number of lamellae. In addition, it has been shown that the air flow can be positively influenced by the arrangement and design of the filter, since a particularly large contact area between the filter and the air flow is provided.

In a second aspect, the invention relates to a dust collection box for a power tool, wherein the dust collection box is designed to extract dust-laden air from a working region of the power tool and to filter out the dust from the dust-laden air by means of a filter such that the dust can be collected in an interior space of the dust collection box until the latter is emptied. A virtual center plane can be placed through the dust collection box, the virtual center plane being designed to divide the dust collection box in a sectional illustration, looking from a forward spatial direction, into a first side and a second side, wherein an inlet of the dust collection box for the dust-laden air is arranged predominantly on one side of the dust collection box, while the filter of the dust collection box is arranged predominantly on the other side of the dust collection box. The terms, definitions and technical advantages introduced for the power tool preferably apply analogously to the dust collection box.

Preferably, the virtual center axis divides the dust collection box or its main body into two halves, which are preferably designated as the first half and the second half of the dust collection box. The halves of the dust collection box are preferably substantially the same or similar in size.

It is preferred within the meaning of the invention that the first side of the dust collection box can be designated as the left side, while the second side of the dust collection box can be designated as the right side. In this case, the dust collection box is viewed from a forward spatial direction, wherein the front side or the forward spatial direction of the dust collection box is preferably determined by the position of the filter and the rear side or the rearward spatial direction of the dust collection box is determined by the position of the inlet for the dust-laden air.

It is preferred within the meaning of the invention that a larger part of the inlet of the dust collection box is arranged on the one side of the dust collection box, while a smaller part of the inlet of the dust collection box is arranged on the other side of the dust collection box. It is further preferred within the meaning of the invention that the larger part, i.e. the predominant part of the filter, is arranged on the one side of the dust collection box, while the smaller part of the filter is arranged on the other side of the dust collection box, with the larger portions of the inlet and the filter being arranged on respectively opposite sides of the dust collection box.

It is preferred within the meaning of the invention that at least one seal of the dust collection box is integrated in a filter frame of the dust collection box. In addition, it may be preferred within the meaning of the invention that the filter is designed as a lamella filter, wherein the air flow through the dust collection box strikes substantially perpendicularly against the lamellae of the lamella filter.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form sensible further combinations.

Identical and similar components are denoted by the same reference signs in the figures.

In the figures:

FIG. 1 shows a front view of a preferred configuration of the dust collection box with a virtual center plane

FIG. 2 shows a side view of a preferred configuration of the dust collection box

FIG. 3 shows a schematic illustration of a preferred configuration of a power tool and of the definition of the virtual center plane

FIG. 4 shows a schematic illustration of a preferred configuration of a power tool with a dust collection box

FIG. 5 shows a schematic illustration of a preferred configuration of a power tool with a dust collection box, and the inlet and outlet regions thereof

FIG. 6 shows a further schematic illustration of a preferred configuration of a power tool with a dust collection box, and the inlet and outlet regions thereof

FIG. 7 shows a schematic illustration of a preferred dust collection box and its components.

### DETAILED DESCRIPTION

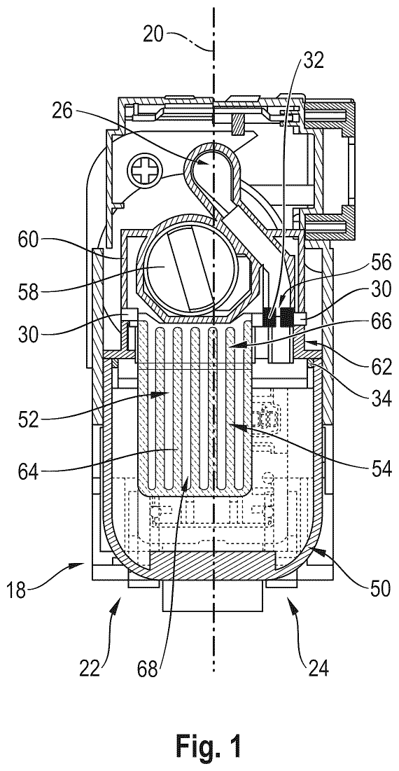

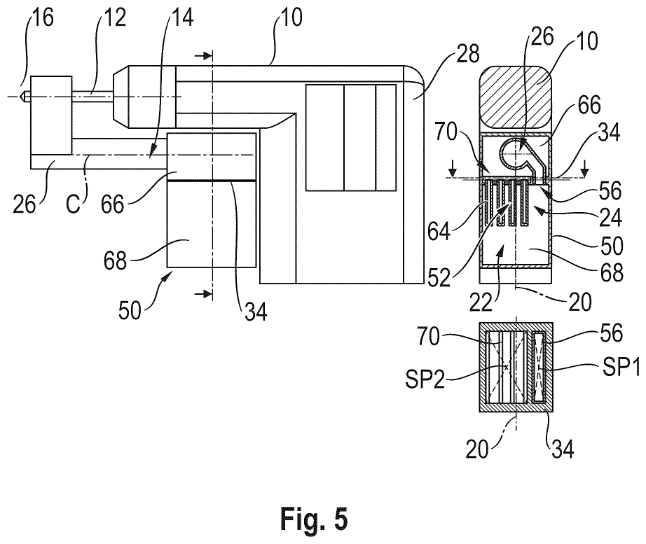

FIG. 1 shows a front view of a preferred configuration of the dust collection box 50 with a virtual center plane 20. As shown in FIG. 1, the virtual center plane 20 divides the dust collection box 50 into two halves 22, 24 which are substantially equal or similar in size. The first or left half 22 in the exemplary embodiment shown in FIG. 1 comprises the predominant part of the filter 52 of the dust collection box 50, while the second or right half 24 of the dust collection box 50 comprises the predominant part of the inlet 56 for the dust-laden air 14 (see FIG. 5). The dust collection box 50 has an inner region 54, wherein the inner region 54 of the dust collection box 50 preferably serves as a dust collection container. The inner region 54 of the dust collection box 50 or the dust collection box 50 can be divided by a third seal 34 into an upper region 66 and into a lower region 68. The filter 52 of the dust collection box 50 is preferably formed by a lamella filter with lamellae 64.

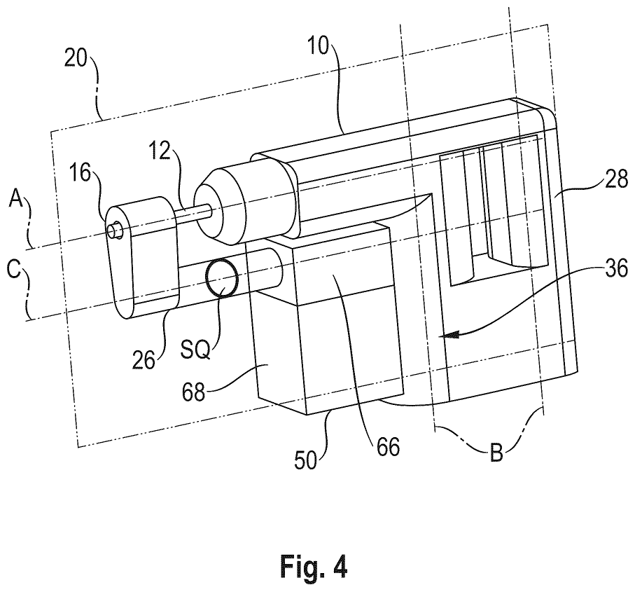

The dust-laden air 14 is sucked in in the working region 16 (see FIG. 4) of the power tool 10 (see FIG. 4) and transported via the suction channel 26 in the direction of the inlet 56 of the dust collection box 50 (see FIG. 1). The dust-laden air 14 passes through the inlet 56 and thus enters the interior 54 of the dust collection box 50, where the predominant part of the dust is deposited on the bottom or on the deepest part of the dust collection box 50, depending on the working direction. The air flow is sucked through the adjacent filter 52 in the direction of the suction unit 58. From there, the air enters the intake chamber of the fan 58 through a perforated bottom of the air guide element 60. After the air from the suction unit 58 has been brought to an increased pressure level, it flows through outlet slots out of the dust collection box 50.

FIG. 1 also illustrates the first seal 30 and the second seal 32. The first seal 30 is symbolized by white blocks, while the second seal 32 is symbolized by black blocks. In addition, FIG. 1 depicts the filter frame 62 in which the seals 30, 32, 34 can be integrated.

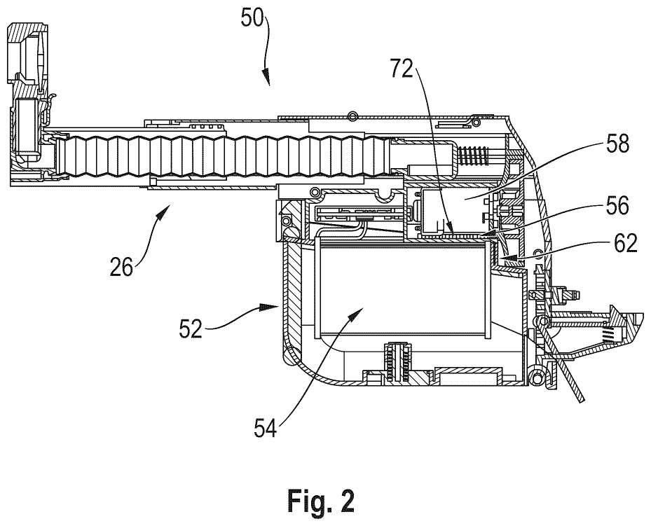

FIG. 2 shows an illustration of a preferred configuration of the dust collection box 50 with a suction channel 26 and a dust collection container 54. In addition, FIG. 2 shows a perforation 72 in the region of the inlet region 56 of the dust collection box 50, and also the filter frame 62.

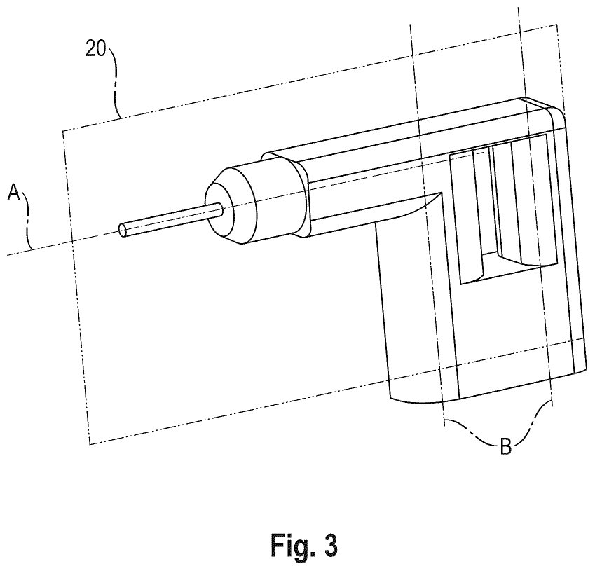

FIG. 3 shows a schematic illustration of a preferred configuration of a power tool 10 and of the definition of the virtual center plane 20. The virtual center plane 20 is preferably defined by a first axis A and a second axis B. The first axis A is preferably the axis of rotation and/or impact axis of the power tool 10. The second axis B is preferably the motor axis or main handle axis of the power tool 10. The first axis A and the second axis B are preferably perpendicular to each other and thus define the virtual center plane 20.

FIG. 4 shows a schematic illustration of a preferred configuration of a power tool 10 with a dust collection box 50. FIG. 4 shows the tool 12, the handle 28, the suction channel 26 and the working region 16 of the power tool 10. The third axis C, which in the exemplary embodiment of the invention shown in FIG. 4 runs substantially parallel to the first axis A of the power tool 10, preferably runs through the suction channel 26. The first axis A and the third axis C run substantially perpendicular to the second axis B. The dust-laden air 14 is sucked through the suction channel 26 from the working region 16 of the power tool 10 in the direction of the dust collection box 10. The reason for this is the suction unit 58 of the dust collection box 50, which generates a negative pressure and thus a suction flow. The suction channel 26 has a flow cross section SQ, through which the dust-laden air 14 flows in the direction of the dust collection box 50. The axis C, which preferably runs in the middle or centrally through the suction channel 26, is preferably perpendicular to the flow cross section SQ of the suction channel 26. It is preferred within the meaning of the invention that the dust-laden air 14 flows along the third axis C such that a flow direction of the dust-laden air and the third axis C run substantially parallel or collinearly to each other. It is preferred within the meaning of the invention that the second axis B runs through the motor 36 of the power tool 10. Alternatively, the second axis B preferably runs through the handle 28 of the power tool 10. This handle 28 can preferably be in the form of what is referred to as a gun handle.

FIG. 4 also shows a preferred configuration of the dust collection box 50. The dust collection box 50 has a lower region 68 with an inlet 56, a filter 52 and an outlet 70, and an upper region 66. (See also FIG. 5). The dust-laden air passes from the suction channel 26 of the power tool 10 via the inlet 56 into the dust collection box 50. There, some of the dust can accumulate in the lowest lying region of the dust collection box 50, with the air being sucked further in the direction of the suction unit 58, or flowing there, because of the negative pressure generated by the suction unit 58. In this case, the air passes the transition region between the lower region 68 and the upper region 66 of the dust collection box 50, with the filter 52 being arranged in this transition region. The filter 52 is designed to filter the dust-laden air such that, in particular, low-dust or filtered air enters the upper region 66 of the dust collection box 50.

The dust collection box 50 may have different seals 30, 32, 34, the first seal 30 being designed to guide the dust-laden air 14 into the dust collection box 50 (see also FIG. 1). The second seal 32 can be used to direct the cleaned air from the filter 52 to a suction unit 58 or fan 58 of the dust collection box 50. The third seal 34 is designed to separate the dust collection box 50 into an upper region 66 and a lower region 68 (see FIGS. 4 to 7). The lower region 68 of the dust collection box 50 comprises the inlet 56 and the outlet 70 of the dust collection box 50, with the filter 52 being arranged in the region of the outlet 70. The filter 52 represents the transition between the lower region 68 and the upper region 66 of the dust collection box 50, wherein dust-laden air is present in the lower region 68 and low-dust air is present in the upper region 66. The filter 52 is preferably designed as a lamella filter with lamellae 64 and designed to filter dust out of the air flow. This reduces the dust load of the air as it passes through the filter 52 or during the transition from the lower region 68 to the upper region 66 of the dust collection box 50.

FIG. 5 shows a schematic illustration of a preferred configuration of a power tool 10 with a dust collection box 50, and also the inlet region 56 and outlet region 70 thereof. The left side of FIG. 5 shows a preferred configuration of the power tool 10, which comprises a tool 12, a handle 28 and a suction channel 26. In the working region 16 of the power tool 10, a substrate can be processed, with dust and dirt being produced during this processing and being able to be extracted using the dust collection box 50.

The right, upper side of FIG. 5 shows a section through the power tool 10. The sectional illustration in the upper region shows the power tool 10 and the dust collection box 50 therebelow. The dust collection box 50 is divided into an upper region 66 and into a lower region 68, wherein the filter 52 of the dust collection box 50 is arranged between the upper region 66 and the lower region 68. In addition, a third seal 34 may be provided in the transition region between the lower region 68 and the upper region 66 of the dust collection box 50, said third seal sealing the regions 66, 68 of the dust collection box 50 in relation to one another. The provision of the third seal 34 makes it possible for the region 68 of the dust collection box 50, in which dust-laden air is located, to be sealed from the region 66 of the dust collection box 50, in which low-dust air is located.

FIG. 5 also illustrates the virtual plane 20, which divides the dust collection box 50 and the power tool 10 into a first half 22 and a second half 24. The predominant part of the filter 52 of the dust collection box 52 is preferably located in the first half 22, while the predominant part of the inlet region 56 of the dust collection box is provided in the second half 24. The inlet region 56 of the dust collection box has a flow or inlet cross section, which can have a first centroid SP1. For example, if the inlet cross section is rectangular, the first centroid SP1 may correspond, for example, to the intersecting point of the diagonals of the inlet cross section. The inlet region 56 and its first centroid SP1 are preferably present in the first half 22 of the power tool 10 or of the dust collection box 50. A second centroid SP2 for the outlet region 70 of the dust collection box 50 can be defined in an analogous manner, wherein the outlet region 70 and its second centroid SP2 are preferably in the second half 24 of the power tool 10 or of the dust collection box 50.

On the right, lower side of FIG. 5, a further section through the power tool 10 is shown, said sectional illustration showing the transition region between the lower region 68 and the upper region 66 of the dust collection box 50. The filter 52 and the third seal 34 of the dust collection box 50 may be arranged in said transition region. In particular, the right, lower side of FIG. 5 shows the arrangement of the inlet region 56 and of the outlet region 70 of the dust collection box 50 on the different sides 22, 24 of the dust collection box 50. While the inlet region 56 and the first centroid SP1 of the dust collection box 50 are present on the first side 22 of the virtual center plane 20, the outlet region 70 and the second centroid SP2 of the dust collection box 50 are present on the second side 24 of the virtual center plane 20.

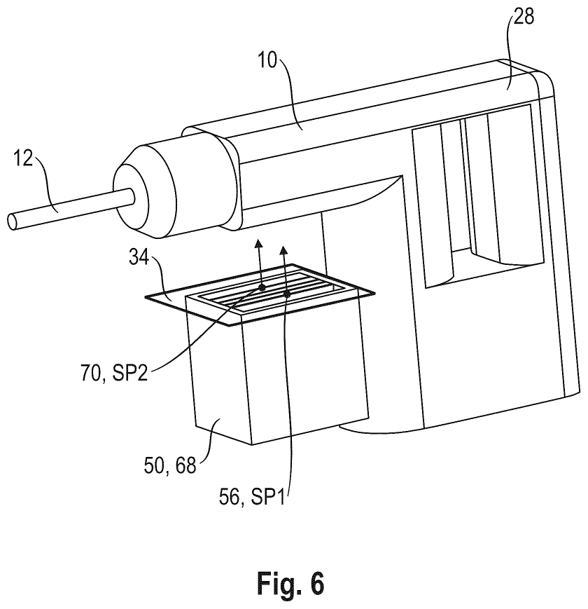

FIG. 6 shows a further schematic illustration of a preferred configuration of a power tool 10 with a dust collection box 50, and also the inlet region 56 and outlet region 70 thereof. In particular, FIG. 6 shows the lower region 68 of the dust collection box 50 in order to illustrate the position of the inlet region 56 and the first centroid SP1, and the position of the outlet region 70 and the second centroid SP2. In addition, FIG. 6 shows the third seal 34, which can represent a sealing plane for sealing the upper region 66 and the lower region 68 of the dust collection box 50 from each other.

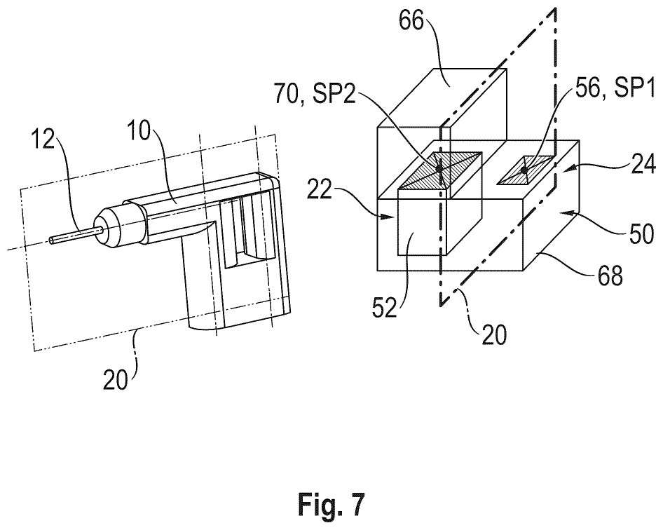

FIG. 7 shows a schematic illustration of a preferred dust collection box 50 and its components. In particular, FIG. 7 shows the virtual center plane 20, which divides the dust collection box 50 into a first half 22 and a second half 24. On the first side 22 of the dust collection box 50 the filter 52, the outlet region 70 and its centroid SP2 are present, while on the second side 24 the inlet region 56 and its centroid SP1 are present. While the virtual center plane 20 divides the dust collection box 50 or the power tool 10 in the vertical direction in two halves 22, 24, the dust collection box 50 is divided in the horizontal direction into an upper region 66 and a lower region 68. The filter 52 and the third seal 34 of the dust collection box 50 may be present in the transition region between the regions 66, 68 of the dust collection box 50.

### LIST OF DESIGNATIONS

10 Power tool
12 Tool
14 Dust-laden air
16 Working region of the power tool
18 Main body of the power tool
20 Virtual center plane
22 First side or first half
24 Second side or second half
26 Suction channel
28 Handle of the power tool, especially gun handle
30 First seal
32 Second seal
34 Third seal
36 Motor of the power tool
50 Dust collection box
52 Filter
54 Interior space of the dust collection box
56 Inlet of the dust collection box
58 Suction unit of the dust collection box
60 Air guide element
62 Filter frame
64 Lamellae
66 Upper region of the dust collection box
68 Lower region of the dust collection box
70 Outlet of the dust collection box
72 Perforation in the region of the inlet region of the dust collection box
A First axis (axis of rotation and/or impact axis)
B Second axis (motor axis or main handle axis)
C Third axis (axis through the suction channel)
SQ Flow cross section
SP1 First centroid, centroid of the inlet cross section
SP2 Second centroid, centroid of the outlet cross section

What is claimed is:

1-13. (canceled)

14: A power tool connectable to an elongate tool extending forward in a spatial direction, the power tool designed to drive the tool to perform a rotating or striking movement, the power tool comprising:
a releasably connectable dust collection box designed to extract dust-laden air from a working region of the power tool and to filter out the dust from the dust-laden air via a filter such that the dust can be collected in an interior space of the dust collection box until the dust collection box is emptied; and
a main body defining a virtual center plane, the virtual center plane dividing the main body in a sectional illustration, looking from a forward spatial direction, into a first side and a second side;
the dust collection box having an inlet for the dust-laden air arranged predominantly on the first side, while the filter is arranged predominantly on the second side.

15: The power tool as recited in claim 14 wherein the dust-laden air is guidable from the working region through a suction channel to the inlet, the virtual center plane running through the suction channel.

16: The power tool as recited in claim 15 wherein the suction channel is telescopic.

17: The power tool as recited in claim 14 further comprising a seal designed to direct the dust-laden air into the dust collection box.

18: The power tool as recited in claim 14 wherein the dust collection box has a seal designed to direct purified air from the filter to a suction unit of the dust collection box.

19: The power tool as recited in claim 14 wherein the power tool has a first seal for conducting the dust-laden air into the dust collection box and a second seal for conducting the purified air from the filter to a suction unit of the dust collection box, the first seal and the second seal being oriented in a same spatial direction.

20: The power tool as recited in claim 14 wherein the dust collection box has an air guide element formed integrally.

21: The power tool as recited in claim 14 wherein the dust collection box has a seal designed to seal an upper region of the dust collection box in relation to a lower region of the dust collection box.

22: The power tool as recited in claim 17 wherein the seal is integrated in a filter frame of the dust collection box.

23: The power tool as recited in claim 14 wherein the filter is designed as a lamella filter, with the air flow through the dust collection box striking perpendicularly against lamellae of the lamella filter.

24: A dust collection box for a power tool as recited in claim 14, the dust collection box comprising:
an inlet for dust-laden air arranged predominantly on one side of a virtual plane dividing the dust collection box, while the filter of the dust collection box is arranged predominantly on the other side of the virtual plane.

25: The dust collection box as recited in claim 24 further comprising a filter frame and at least one seal integrated in the filter frame.

26: The dust collection box as recited in claim 24 wherein the filter is designed as a lamella filter, with the air flow through the dust collection box striking perpendicularly against the lamellae of the lamella filter.
